(19) United States
(12) Patent Application Publication
(10) Pub. No.: US 2025/0101935 A1
(43) Pub. Date: Mar. 27, 2025

(54) COATING SYSTEM WITH FUNCTIONALIZED PARTICLES

(71) Applicant: GM Global Technology Operations LLC, Detroit, MI (US)

(72) Inventors: Seongchan Pack, West Bloomfield Township, MI (US); Matthew G. Keast, Clawson, MI (US); Andrew William Kneifel, Northville, MI (US)

(21) Appl. No.: 18/474,487

(22) Filed: Sep. 26, 2023

(51) Int. Cl. F02M 35/10

(52) U.S. Cl. CPC F02M 35/10268; F02M 35/10091; F02M 35/10334; F02M 35/10347

(57) ABSTRACT

A coating system is disclosed. The coating system includes a coating disposed on a substrate and a plurality of functionalized particles within the coating. The plurality of functionalized particles is configured to dissipate localized thermal flux from the substrate, where at least a portion of the plurality of functionalized particles are aligned.

### INTRODUCTION

The present disclosure relates to a coating system and method, and more particularly, a coating system configured to dissipate heat from a substrate.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Coating systems can be used to protect a substrate and to give the substrate a desirable appearance. Surface patterns in coating systems can be highly distorted in environments with elevated temperatures, high humidity, thermal radiation, and/or UV radiation, for example within a vehicle engine environment. Because of the elevated temperatures and high humidity, controlling surface properties of the patterned coating systems can be challenging.

While prior art methods and systems for minimizing or preventing distortion of coating systems exist, a new and improved coating system with distortion prevention is needed. Accordingly, a coating system that includes a plurality of aligned functional particles is disclosed.

### SUMMARY

According to several aspects of the present disclosure, a coating system is provided. The coating system includes a coating disposed on a substrate and a plurality of functionalized particles within the coating. The plurality of functionalized particles is configured to dissipate localized thermal flux from the substrate, where at least a portion of the plurality of functionalized particles are aligned.

In accordance with another aspect of the disclosure the coating system further includes a substrate that is at least one of metal or plastic and is integrated with a bore for air flow.

In accordance with another aspect of the disclosure the coating system further includes a substrate that is a vehicle intake manifold.

In accordance with another aspect of the disclosure the coating system further includes a coating that includes an appearance surface.

In accordance with another aspect of the disclosure the coating system further includes a coating that includes an appearance surface having a surface roughness between 15 and 35 microns average roughness (Ra)/areal average roughness (Sa).

In accordance with another aspect of the disclosure the coating system further includes a coating that includes an appearance surface having a surface roughness that is surface patterned with a matte finish.

In accordance with another aspect of the disclosure the coating system further includes a plurality of functionalized particles that have a high adhesive strength and a high heat dissipative capability.

In accordance with another aspect of the disclosure the coating system further includes a plurality of functionalized particles that have a stacking angle of between 30° and 160° and a thermal conductivity greater than 0.3 watts per meter-Kelvin (W/mK).

In accordance with another aspect of the disclosure the coating system further includes a plurality of functionalized particles that are at least one of an organic or an inorganic conductive additive.

In accordance with another aspect of the disclosure the coating system further includes a plurality of functionalized particles that are between one nanometer and two micrometers in size.

In accordance with another aspect of the disclosure the coating system further includes a plurality of functionalized particles that is graphene.

In accordance with another aspect of the disclosure the coating system further includes a plurality of functionalized particles that is iron based.

In accordance with another aspect of the disclosure the coating system further includes a plurality of functionalized particles that includes plates.

In accordance with another aspect of the disclosure the coating system further includes a coating in an alternating curvature configuration.

In accordance with another aspect of the disclosure, a vehicle propulsion system includes an engine having a manifold body and a coating system coupled to the manifold body. The coating system includes a coating disposed on the manifold body and a plurality of functionalized particles within the coating configured to dissipate localized thermal flux from the manifold body. At least a portion of the plurality of functionalized particles are aligned, at least a portion of the plurality of functionalized particles are sheets, and the plurality of functionalized particles have a thermal conductivity greater than 0.3 W/mK.

In accordance with yet another aspect of the disclosure, a method for forming a heat dissipating coating system is disclosed. The method includes applying a coating to a manifold body so that the coating is adhered to the manifold body, where the coating includes a plurality of functionalized particles configured to dissipate localized thermal flux from the manifold body. The method further includes aligning at least a portion of the plurality of functionalized particles within the coating so that the portion of the plurality of functionalized particles have a stacking angle between 30° and 160°. Additionally, the method includes solidifying the coating with the aligned plurality of functionalized particles.

In accordance with yet another aspect of the disclosure, applying the coating to the substrate includes at least one of painting, casting, injection molding, or additive manufacturing the coating.

In accordance with yet another aspect of the disclosure, aligning the plurality of functionalized particles includes applying a magnetic field to the plurality of functionalized particles.

In accordance with yet another aspect of the disclosure, the coating system includes an undulated surface pattern with ridges having widths and heights that are the same.

In accordance with yet another aspect of the disclosure, the coating system is configured to prevent a color shift of the coating.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is an environmental view illustrating an example of a vehicle propulsion system with a substrate having a coating system configured to dissipate a localized heat flux from a substrate, for example the manifold body, in accordance with the present disclosure.

FIG. 2A is a side cross section view of the coating system illustrated in FIG. 1, illustrating the coating system includes a coating having a plurality of aligned functionalized particles, in accordance with the present disclosure.

FIG. 2B is a side cross section view of a coating system including a coating with a plurality of unaligned functionalized particles, in accordance with the present disclosure.

FIG. 3A is a side cross section view of a first functionalized particle and a second functionalized particle aligned in a linear arrangement, in accordance with the present disclosure.

FIG. 3B is a side cross section view of an aligned first functionalized particle and second functionalized particle aligned in an overlapping arrangement with a stacking angle, in accordance with the present disclosure.

FIG. 4A is a top view of the coating system illustrated in FIGS. 1 and 2A, where the coating system is not distorted, includes aligned functional particles, and is configured in an undulated pattern having ridges and valleys with widths and heights that are the same, in accordance with the present disclosure.

FIG. 4B is a top view of the coating system illustrated in FIG. 2B, where the coating system is distorted, does not include aligned functional particles, and is configured in an undulated pattern showing ridges and valleys with inconsistent widths and heights, in accordance with the present disclosure.

FIG. 5 is a flowchart of a method for forming the heat dissipating coating system illustrated in FIG. 1, where the coating system includes a coating having a plurality of aligned functionalized particles, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

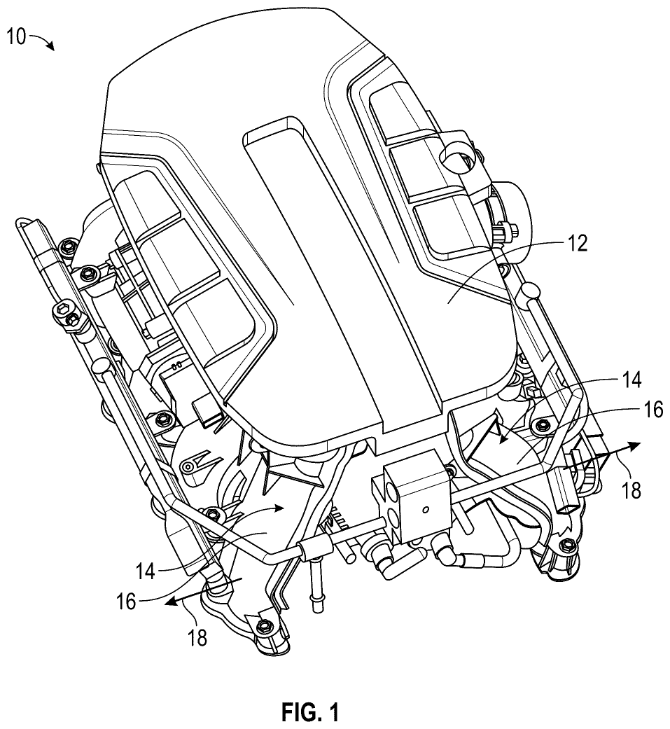

FIG. 1 illustrates a vehicle propulsion system 10 in accordance with an exemplary embodiment. The vehicle propulsion system 10 can include an engine 12, for example an automobile internal combustion engine, configured to provide power to a vehicle (not shown). The engine 12 can emit energy and/or heat in the case of an internal combustion engine. However, as used herein, the term “vehicle” and “engine” are not limited to automobiles. While the present technology is described primarily herein in connection with automobiles, the technology is not limited to automobiles. The concepts can be used in a wide variety of applications, such as in connection with aircraft, marine craft, other vehicles, as well as hospitals, healthcare and medical facilities, fuel cells, and consumer electronic components.

Additionally, as illustrated in FIG. 1, the vehicle propulsion system 10 can include a substrate 14 (e.g., a manifold body, a fuel cell housing, and the like). In the instance where the substrate 14 is a manifold body, the manifold body can include a vehicle intake manifold or an inlet manifold of an engine that distributes air to the cylinders of the vehicle engine 10. Additionally, in some instances, a manifold body may include fuel injectors and/or may take in a fuel-air mixture from a carburetor and/or throttle body to the cylinder heads. In these implementations, the manifold body can include at least one of metal or plastic and may be integrated with a bore for air flow. Heat and/or energy from the engine (e.g., from a combustion reaction) can be conducted through the substrate 14 and/or manifold body.

FIG. 1 further illustrates a coating system 16 (e.g., a surface patterned heat dissipating coating system) disposed on the substrate 14. The coating system 16 can be configured to dissipate heat from the engine 12 and conduct a localized thermal flux 18 away from the substrate 14. In some instances, the coating system 16 can be exposed to high temperature and/or high humidity in a vehicle engine 10, which may make control of surface properties of coating systems difficult. Because the coating system 16 can be configured to dissipate heat and energy from the substrate 14, surface properties of the coating system 16 can be better controlled and distortion minimized or prevented. It is contemplated that the coating system can be disposed on and/or included as a portion of another component of an engine or a system.

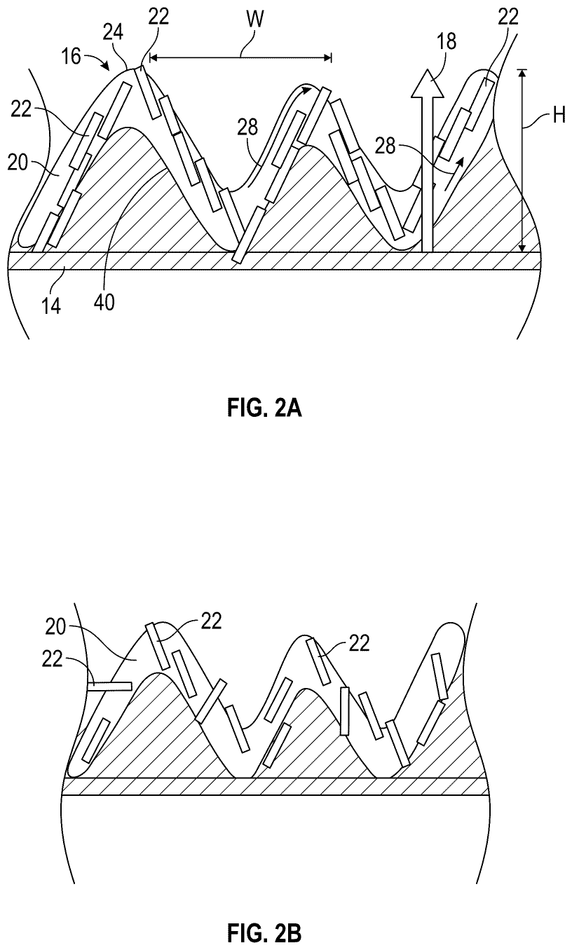

As depicted in FIG. 2A, the coating system 16 can include a coating 20 having a plurality of functionalized particles 22, where the coating 20 is disposed on the substrate 14. The coating 20 can include, for example, epoxy and/or phenolic coating, polyester coating, elastomer coating, and/or thermal spray coating. For example, the coating 20 can include a polymer-based automobile engine paint configured to adhere to the substrate 14 (e.g., manifold body).

Additionally, the coating 20 can include a surface pattern and/or an appearance surface. For example, the surface pattern and/or appearance surface can appear shiny, have a matte finish (e.g., lacking luster), or the like, and can include a surface roughness and a surface tension. In a specific example, surface roughness of the coating 20 ranges from 15-35 microns average roughness (Ra)/areal average roughness (Sa). In the example illustrated in FIG. 2A, the coating 20 is shown in a partial side cross-sectional view having an appearance surface and surface roughness configured in a wrinkle pattern, where the wrinkle pattern includes an undulated surface including alternating ridges 24 and valleys 26 with consistent widths W and/or an alternating curvature configuration. In the specific example shown in FIG. 2A, the alternating ridges 24 and valleys 26 have consistent patterns in width W and/or height H, which is a result of the thermal-dissipative characteristic of the coating system 16. The surface pattern may be determined by and mimic morphology-driven surface patterns of substrate 14, in this example by the manifold body (having a rough surface). It will be appreciated that coating 20 can also be configured in other surface pattern configurations.

As depicted in FIG. 2A, the coating system 16 can include a plurality of functionalized particles 22 (e.g., micro-heat reflectors) disposed within a passage along a length of the coating 20, where at least a portion of the functionalized particles 22 are aligned and/or connected. The passage can include path 28 along a length of the coating 20 between a coating inner surface 30 (e.g., surface proximate to the substrate 14) and a coating outer surface 32 (e.g., surface distal from the substrate 14). The path 28 can be linear (e.g., generally along a single axis) or can be non-linear (e.g., along multiple axes in an undulated pattern, for example in a coating 20 wrinkle configuration).

The functionalized particles 22, in the example illustrated in FIG. 2A, can be configured as plates (e.g., rectangular, square, and/or sheets). Additionally, functionalized particles 22 can include other forms. For example, the functionalized particles 22 can be disks, cylinders, tubes, rectangles, or the like. The plurality of functionalized particles 22 can be formed of varying material configured to conduct and/or dissipate heat and energy, for example an organic/inorganic additive (e.g., graphenemetallic additive, for example, iron or iron-based, e.g., an iron alloy, steel, and the like). Some specific examples of functionalized particles 22 include oxidized graphene, zinc oxide, copper oxide, zinc phosphate, and hydrated phosphate with metals. Further, the functionalized particles 22 can vary in size, for example between one nanometer and two micrometers in size. In some implementations, the functionalized particles 22 can be consistent in size (e.g., generally about 0.5 micrometers), and in other implementations, the functionalized particles 22 can include varying sizes (e.g., half are 0.5 micrometers and half are 0.3 micrometers). Additionally, the functionalized particles can be disposed within the coating 20, as illustrated in FIG. 2A, partially in the coating 20 and partially out of the coating 20, and/or on a surface of the coating 20.

FIG. 2B illustrates an example of the coating system 16 including a coating 20 having a plurality of functionalized particles 22 that are not aligned. These functionalized particles 22 are arranged in a random orientation and generally do not touch or contact other functionalized particles. This arrangement does not provide good energy and heat dissipation compared to the configuration depicted in FIG. 2A, at least because of a lack of heat conductivity between each functionalized particle and inefficient heat reflection. In the configuration shown in FIG. 2B, distortion of the coating 20 occurs.

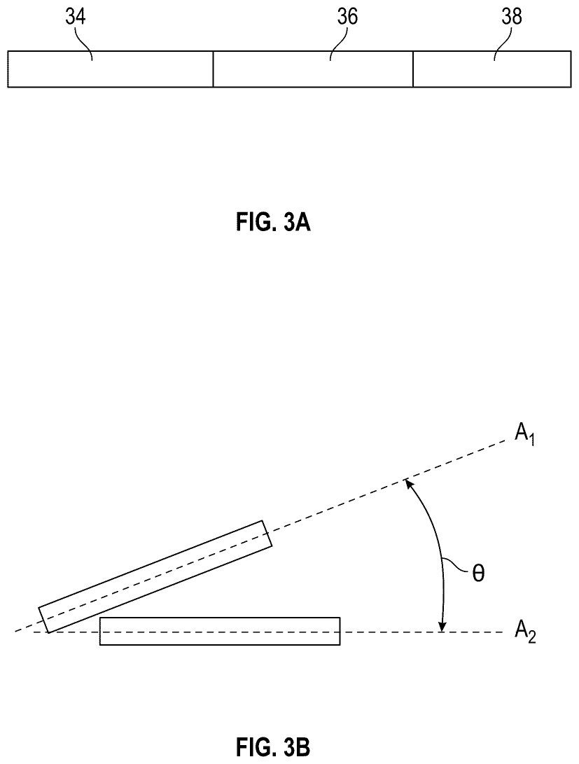

As illustrated in FIG. 3A, each functionalized particle 22 may touch and/or contact another functionalized particle 22 in a linear configuration, for example where an end of a first functionalized particle 34 contacts only an end of a second functionalized particle 36. Aligned functionalized particles 22 can occur, for example, when the first functionalized particle 34 touches and/or contacts the second functionalized particle 36 in a generally longitudinal orientation, and a third functionalized particle 38 can touch and/or connect to the second functionalized particle 36 in a repeating longitudinal direction and with other of the plurality of functionalized particles 22 such that energy and heat can be conducted between each functionalized particle 22 and dissipated and/or reflected from the substrate 14 and coating system 16.

In other instances, as shown in FIG. 3B, the functionalized particles 22 can be aligned and contact each other in an overlapping configuration and can include a stacking angle θ (e.g., between 30° and 160°, vertical, and so forth) between each functionalized particle 22, where the stacking angle θ can include an angle between a longitudinal axis A₁ of a first functionalized particle and a longitudinal axis A₂ of a second functionalized particle. In one specific instance, the functionalized particles 22 can include a stacking angle θ between 30° and 160°. It is contemplated that the functionalized particles 22 may include other stacking angles, for example less than 30° including 0°.

Further, the functionalized particles 22 can have high thermal conductivity, a high adhesive strength, and/or a high heat dissipative capability. In a specific instance, the functionalized particles 22 can include a thermal conductivity of 0.3 watts per meter-Kelvin (W/mK) or greater. The aligned functionalized particles 22 can serve to effectively dissipate localized thermal flux 18 from a substrate 14 (e.g., manifold body), which serves to prevent and/or minimize distortion of the coating 20, (e.g., color distortion or color shift, thermal adhesive strength of the coating 20 to a joint interface 40, uniformity of diffractions, and/or surface pattern).

In one specific example, a coating system 16 with aligned functionalized particles 22 in the arrangement illustrated in FIG. 2A, was subjected to a similar temperature of 120° C. for approximately 168 hours resulting in no distortion of the color or the surface pattern of the coating system 16. In a second specific example, a coating system 16 with randomized and unaligned functionalized particles 22 in the arrangement illustrated in FIG. 2B was subjected to a temperature of 120° C. for approximately 168 hours resulting in distortion of the color and surface pattern of the coating system 16. The first example illustrates that addition of the aligned functionalized particles 22 to the coating system 16 results in more efficient heat dissipation from the coating system 16 and minimized distortion of the coating system 16.

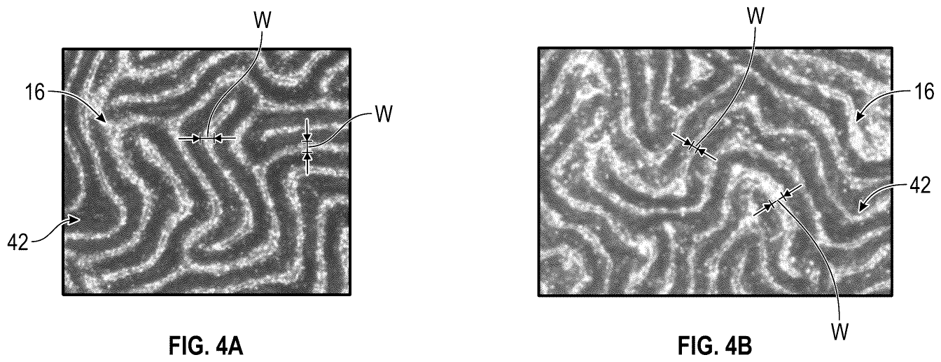

FIGS. 4A and 4B illustrate plan view examples of surface patterns 42 of the coating system 16. In FIG. 4A, a plan view of a surface pattern 42 is shown in accordance with the example illustrated in FIG. 2A, where the functionalized particles 22 are aligned. In this example, the surface pattern 42 is not distorted, and the widths W between ridges and/or valleys are uniform and consistent. This configuration results in uniformity of diffraction and stable coloration of the coating system 16 across surface patterns. FIG. 4B illustrates a plan view of a surface pattern 42 in accordance with the example illustrated in FIG. 2B, where the functionalized particles 22 are not aligned resulting in a distorted surface pattern with differing and inconsistent widths W. This configuration results in distorted diffractions and damaged coloration of the coating system 16. The differing widths of the surface pattern 42 shown in FIG. 4B are indicative of damage and distortion to the coating system 16 because of ineffective heat dissipation.

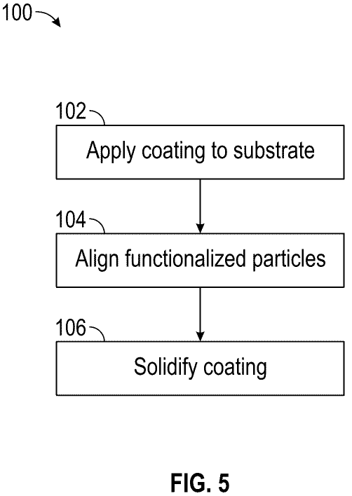

FIG. 5 illustrates a method 100 for forming the coating system 16 as illustrated in FIGS. 1 through 2A and 3A through 4A.

Step 102 depicts applying the coating 20 to the substrate 14, where the coating 20 includes a plurality of functionalized particles 22 configured to dissipate localized thermal flux from the substrate 14 (e.g., manifold body). Applying the coating 20 can include using methods, for example, painting, casting, injection molding, and/or additive manufacturing. In one example, coating 20 can be painted on substrate 14 using a brush or by spraying a vehicle paint onto a vehicle manifold body. In another example, coating 20 can be applied to substrate 14 using a casting (e.g., spin casting) process, where coating 20 is poured into a casting mold, for example a disc-shaped mold, which spins along its central axis, and spun at a set speed. In some instances, the coating 20 can solidify in the mold and then be coupled to the substrate 14. It is contemplated that other types of casting may be used. In yet another example of applying the coating 20, coating 20 can be applied to substrate 14 using an injection molding process where the coating 20 is injected into a mold with a desired configuration. In a further example, coating 20 can be applied to substrate 14 using an additive manufacturing process, for example 3D printing. In this specific example, coating 20 can be applied to substrate 14 one single or several layers at a time. It is contemplated that other types of application processes may be used for applying the coating 20.

In some instances, coating 20 can be applied containing the plurality of functionalized particles 22, for example in the cases of painting, spin casting, injection molding, and/or additive manufacturing. In other instances, the plurality of functionalized particles 22 may be added to the coating 20 subsequent to applying the coating 20. For example, the coating 20 may be spray painted on the substrate 14, and then the functionalized particles 22 may be added to the coating 20, for example by spraying or otherwise depositing the functionalized particles 22 into or onto the coating 20.

Step 104 depicts aligning the plurality of functionalized particles 22. Aligning the plurality of functionalized particles 22 can include causing a portion of the functionalized particles 22 to contact each other in a longitudinal configuration, for example the configurations illustrated in FIGS. 2A and/or 2B. In one example, aligning the plurality of functionalized particles 22 can include using a magnetic field from a magnet to cause iron and/or steel-based functionalized particles 22 to align with each other and the magnetic field. In another example, aligning the plurality of functionalized particles 22 can include spin casting a coating 20 containing the functionalized particles 22, where a centrifugal force caused by the spinning action of the spin casting acts on the functionalized particles 22 so that they align with each other in a longitudinal configuration. It is contemplated that other methods may be used to align the functionalized particles 22.

Step 106 illustrates solidifying the coating 20. Solidifying the coating 20 can include causing the coating 20 to at least partially harden and/or become solid. For example, solidifying the coating 20 can include curing the coating 20 by applying a vehicle paint curing agent. In other examples, solidifying the coating 20 can include drying the coating 20 using air and/or heat convection and/or exposing the coating 20 to light (e.g., ultraviolet light).

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A coating system comprising:
a coating disposed on a substrate; and
a plurality of functionalized particles within the coating configured to dissipate localized thermal flux from the substrate, wherein at least a portion of the plurality of functionalized particles are aligned.

2. The coating system of claim 1, wherein the substrate is at least one of metal or plastic and is integrated with a bore for air flow.

3. The coating system of claim 2, wherein the substrate is a vehicle intake manifold.

4. The coating system of claim 1, wherein the coating includes an appearance surface.

5. The coating system of claim 4, wherein the appearance surface has a surface roughness between 15 and 35 microns Ra/Sa.

6. The coating system of claim 5, wherein the surface roughness can be surface patterned with a matte finish.

7. The coating system of claim 1, wherein the plurality of functionalized particles include at least one of zinc oxide, copper oxide, zinc phosphate, or hydrated phosphate with metals.

8. The coating system of claim 1, wherein the plurality of functionalized particles include a stacking angle between 30° and 160° and a thermal conductivity greater than 0.3 W/mK.

9. The coating system of claim 1, wherein the plurality of functionalized particles include at least one of an organic or an inorganic conductive additive.

10. The coating system of claim 1, wherein the plurality of functionalized particles are between one nanometer and two micrometers in size.

11. The coating system of claim 1, wherein the plurality of functionalized particles includes oxidized graphene.

12. The coating system of claim 1, wherein the plurality of functionalized particles are iron based.

13. The coating system of claim 1, wherein the plurality of functionalized particles include plates.

14. The coating system of claim 1, wherein the coating system includes a coating in an alternating curvature configuration.

15. A vehicle propulsion system comprising:
an engine having a manifold body; and
a coating system coupled to the manifold body, the coating system including
a coating disposed on the manifold body; and
a plurality of functionalized particles within the coating configured to dissipate localized thermal flux from the manifold body, wherein at least a portion of the plurality of functionalized particles are aligned, at least a portion of the plurality of functionalized particles are sheets, and the plurality of functionalized particles have a thermal conductivity greater than 0.3 W/mK.

16. A method for forming a heat dissipating coating system, the method comprising:
applying a coating to a substrate so that the coating is adhered to the substrate, where the coating includes a plurality of functionalized particles configured to dissipate localized thermal flux from the substrate;
aligning at least a portion of the plurality of functionalized particles within the coating so that the portion of the plurality of functionalized particles have a stacking angle between 30° and 160°; and
solidifying the coating with the plurality of functionalized particles.

17. The method of claim 16, wherein applying the coating to the substrate includes at least one of painting, casting, injection molding, or additive manufacturing the coating.

18. The method of claim 16, wherein aligning the plurality of functionalized particles includes applying a magnetic field to the plurality of functionalized particles.

19. The method of claim 16, wherein the coating system includes an undulated surface pattern.

20. The method of claim 16, wherein the coating system is configured to prevent a color shift of the coating.
